(19) United States
(12) Patent Application Publication
(10) Pub. No.: US 2026/0054537 A1
(43) Pub. Date: Feb. 26, 2026

(54) VEHICLE CONTROL SYSTEM

(71) Applicant: TOYOTA JIDOSHA KABUSHIKI KAISHA, Toyota-shi (JP)

(72) Inventor: Hiroki FURUTA, Susono-shi (JP)

(73) Assignee: TOYOTA JIDOSHA KABUSHIKI KAISHA, Toyota-shi (JP)

(21) Appl. No.: 19/277,112

(22) Filed: Jul. 22, 2025

(30) Foreign Application Priority Data
Aug. 20, 2024 (JP) 2024-139097

(51) Int. Cl. B60G 17/06

(52) U.S. Cl. CPC B60G 17/06; B60G 2400/252; B60G 2500/10

(57) ABSTRACT

The vehicle control system performs damping control to suppress vibration of the sprung structure on the object wheel. The map shows the correspondence between the up-down motion parameters and the positions associated with the up-down motion of the wheels. The damping control includes a preview control using an up-down motion parameter obtained from the map, and a non-map-dependent control using an up-down motion parameter calculated based on a measurement result by a sensor mounted on the object vehicle. The total gain is the sum of the first gain for the preview control and the second gain for the non-map-dependent control. The predetermined ideal gain is a total gain that minimizes vibration of the sprung structure. The first gain and the second gain are set such that the total gain does not exceed twice the ideal gain.

### CROSS-REFERENCE TO RELATED APPLICATION

This application claims priority to Japanese Patent Application No. 2024-139097 filed on Aug. 20, 2024. The disclosure of the above-identified application, including the specification, drawings, and claims, is incorporated by reference herein in its entirety.

### BACKGROUND

### 1. Technical Field

The present disclosure relates to damping control that is applied to a vehicle. In particular, the present disclosure relates to damping control using a map indicating a correspondence relation between a parameter related to up-down motion of a wheel, and a position.

### 2. Description of Related Art

U.S. 2018/0154723 A discloses a road surface displacement map representing a correspondence relation between a road surface displacement (road surface unevenness) and a position. Damping control is performed by using such a road surface displacement map. Specifically, a road surface displacement at a predetermined position ahead of a vehicle is recognized in advance from the road surface displacement map. A control amount of active suspension is calculated in advance in accordance with the road surface displacement that is recognized in advance. Vibration of the vehicle is effectively suppressed by controlling the active suspension at a timing of a wheel passing this predetermined position.

### SUMMARY

Damping control that is applied to a vehicle will be considered. As an example of the damping control, preview control that uses a map indicating a correspondence relation between a parameter related to up-down motion of a wheel, and a position, is known. Although control performance of the preview control is high, a situation in which reliability of the preview control temporarily decreases is also conceivable. For example, when a road surface state has changed due to road construction or the like and the map becomes old, reliability of the preview control using the old map is not necessarily high.

The present disclosure provides technology that is capable of effectively performing damping control that is applied to a vehicle.

One aspect of the present disclosure relates to a vehicle control system that is applied to an object vehicle.

The object vehicle includes an actuator for applying control force in an up-down direction to a suspension of an object wheel.

The vehicle control system includes one or multiple processors that control the actuator to execute damping control for suppressing vibration in a sprung structure above the object wheel, and one or multiple storage devices that store a map indicating a correspondence relation between an up-down motion parameter related to up-down motion of a wheel, and a position. The damping control includes a preview control that uses the up-down motion parameter that is obtained from the map, and a non-map-dependent control that uses the up-down motion parameter that is calculated based on a measurement result by a sensor that is installed in the object vehicle.

A total gain is a sum of a first gain for the preview control and a second gain for the non-map-dependent control.

An ideal gain is the total gain that minimizes the vibration of the sprung structure, and is set in advance.

The one or multiple processors are configured to set the first gain and the second gain such that the total gain does not exceed twice the ideal gain.

According to the present disclosure, the damping control that is applied to the object vehicle is a combination of preview control and non-map-dependent control. The preview control utilizes the up-down motion parameter that is obtained from the map, while the non-map-dependent control utilizes the up-down motion parameter that is calculated based on measurement results by the sensor. Accordingly, in a situation in which the reliability of the up-down motion parameter that is obtained from the map is low, damping effects are obtained by the non-map-dependent control even in a situation in which the reliability of the preview control is low.

Further, according to the present disclosure, the total gain that is the sum of the first gain for the preview control and the second gain for the non-map-dependent control is also appropriately set. Specifically, the total gain is set so as not to exceed twice the ideal gain for minimizing vibration. When the total gain is more than twice the ideal gain, the vibration may actually become greater as compared to a case in which the damping control is not applied (excitation). According to the present disclosure, the total gain is set so as not to exceed twice the ideal gain, and accordingly the damping effects can be reliably obtained without inviting excitation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration example of a vehicle according to an embodiment;

FIG. 2 is a conceptual diagram illustrating a configuration example of a suspension according to the embodiment;

FIG. 3 is a flowchart illustrating an example of an unsprung displacement calculation process according to the embodiment;

FIG. 4 is a block diagram illustrating a configuration example of the vehicle control system according to the embodiment;

FIG. 5 is a block diagram illustrating an example of driving environment information according to the embodiment;

FIG. 6 is a block diagram illustrating a configuration example of the map management system according to the embodiment;

FIG. 7 is a conceptual diagram for explaining an unsprung displacement map according to the embodiment;

FIG. 8 is a flowchart summarizing map generation and update processing according to the embodiment;

FIG. 9 is a conceptual diagram for explaining preview control using an unsprung displacement map according to the embodiment;

FIG. 10 is a flowchart illustrating preview control using an unsprung displacement map according to the embodiment;

FIG. 11 is a conceptual diagram for describing an example of a method for calculating reliability of preview control according to the embodiment;

FIG. 12 is a conceptual diagram for explaining rear preview control according to the embodiment;

FIG. 13 is a conceptual diagram for explaining the setting of the total gain of the damping control according to the embodiment;

FIG. 14 is a conceptual diagram for describing an example of gain setting in consideration of reliability of preview control according to the embodiment;

FIG. 15 is a conceptual diagram for describing another example of gain setting considering reliability of preview control according to the embodiment; and

FIG. 16 is a conceptual diagram for describing still another example of gain setting in consideration of reliability of preview control according to the embodiment.

### DETAILED DESCRIPTION OF EMBODIMENTS

Embodiments of the present disclosure will be described with reference to the accompanying drawings.

### 1. Suspension and Up-Down Motion Parameters

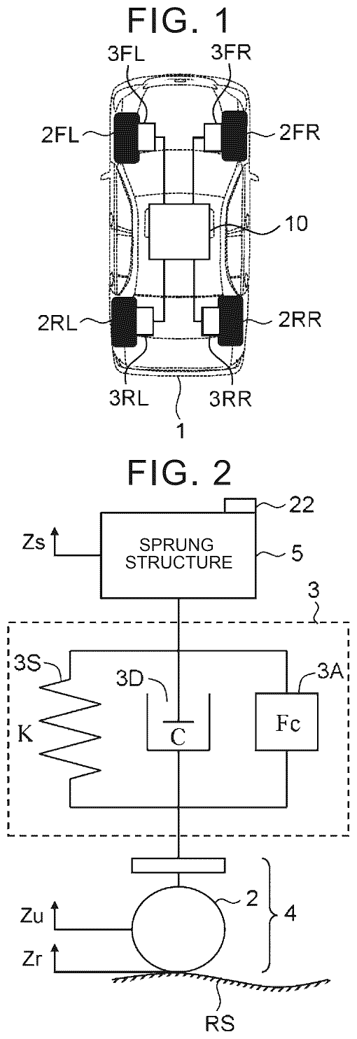

FIG. 1 is a schematic diagram illustrating a configuration example of a vehicle 1 according to the present embodiment. The vehicle 1 includes wheels 2 and a suspension 3. The wheel 2 includes a left front wheel 2FL, a right front wheel 2FR, a left rear wheel 2RL, and a right rear wheel 2RR. Suspension 3FL, 3FR, 3RL and 3RR are provided for each of the left front wheel 2FL, the right front wheel 2FR, the left rear wheel 2RL, and the right rear wheel 2RR. In the following description, each wheel is referred to as a wheel 2, and each suspension is referred to as a suspension 3, particularly when there is no need for distinction.

FIG. 2 is a conceptual diagram illustrating a configuration example of the suspension 3. The suspension 3 is provided to connect between the unsprung structure 4 and the sprung structure 5 of the vehicle 1. The unsprung structure 4 includes wheels 2. The suspension 3 includes a spring 3S, a damper (shock absorber) 3D, and an actuator 3A. The spring 3S, the damper 3D, and the actuator 3A are provided in parallel between the unsprung structure 4 and the sprung structure 5. The spring rate of the spring 3S is K. The damping factor of the damper 3D is C. The damping force of the damper 3D may be variable. The actuator 3A applies an up-down direction control force Fc between the unsprung structure 4 and the sprung structure 5 (acts).

Here, the term is defined. The “road surface displacement Zr” is an up-down direction displacement of the road surface RS. The “unsprung displacement Zu” is the up-down direction displacement of the unsprung structure 4. The “sprung displacement Zs” is an up-down direction displacement of the sprung structure 5. The “unsprung speed Zu′” is the up-down direction speed of the unsprung structure 4. The “sprung speed Zs” is the up-down direction speed of the sprung structure 5. The “unsprung acceleration Zu″” is the up-down direction acceleration of the unsprung structure 4. The “sprung acceleration Zs” is the up-down direction acceleration of the sprung structure 5. Note that the sign of each parameter is positive in the case of the upward direction and negative in the case of the downward direction.

The wheels 2 move on the road surface RS. In the following explanation, a parameter related to the up-and-down movement (vertical motion) of the wheel 2 is referred to as an “up-and-down movement parameter”. Examples of the up-down motion parameter include the road surface displacement Zr, the unsprung displacement Zu, the unsprung velocity Zu′, the unsprung acceleration Zu “, the sprung displacement Zs, the sprung velocity Zs′, and the sprung acceleration Zs”. The up-down motion parameter may also be referred to 25 as a “road surface displacement related parameter” associated with the road surface displacement Zr.

For example, in the following explanation, a case where the up-down motion parameter is the unsprung displacement Zu will be considered. In the case of generalization, “unsprung displacement” in the following description is read as “up-down motion parameter”.

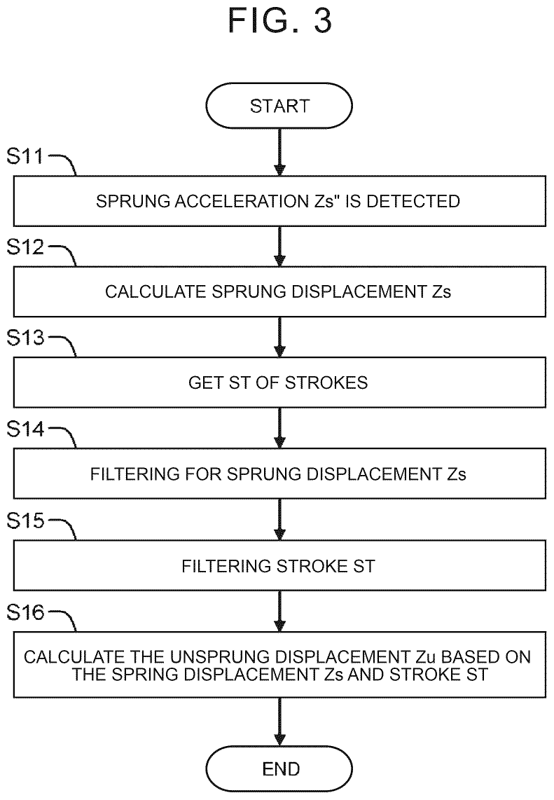

FIG. 3 is a flowchart illustrating an example of unsprung displacement calculation processing.

In S11, the sprung acceleration Zs″ is detected by the sprung acceleration sensor 22 installed in the sprung structure 5. In S12, the sprung displacement Zs is calculated by integrating the sprung acceleration Zs″ on the second floor.

In S13, a stroke ST (=Zs-Zu) is obtained, which is the relative displacement between the sprung structure 5 and the unsprung structure 4. For example, the stroke ST is detected by a stroke sensor installed in the suspension 3. As another example, the stroke ST may be estimated based on the sprung acceleration Zs″ by an observer configured based on a single-wheel two-degree-of-freedom model.

In S14, the time-series data of the sprung displacement Zs is filtered in order to suppress the effect of the sensor drift or the like. Similarly, in S15, the time-series data of the stroke ST is filtered. For example, the filter is a band-pass filter that passes signal components in a specific frequency band. The specific frequency band may be set to include the sprung resonance frequency of the vehicle 1. For example, the particular frequency band is 0.3 Hz to 10 Hz.

In S16, the difference between the sprung displacement Zs and the stroke ST is calculated as the unsprung displacement Zu.

Instead of S14 and S15, the time-series data of the unsprung displacement Zu calculated in S16 may be filtered.

As yet another example, the unsprung acceleration Zu″ may be detected by the unsprung acceleration sensor, and the unsprung displacement Zu may be calculated from the unsprung acceleration Zu″.

### 2. Advanced Vehicle Control System

### 2-1. Configuration Example

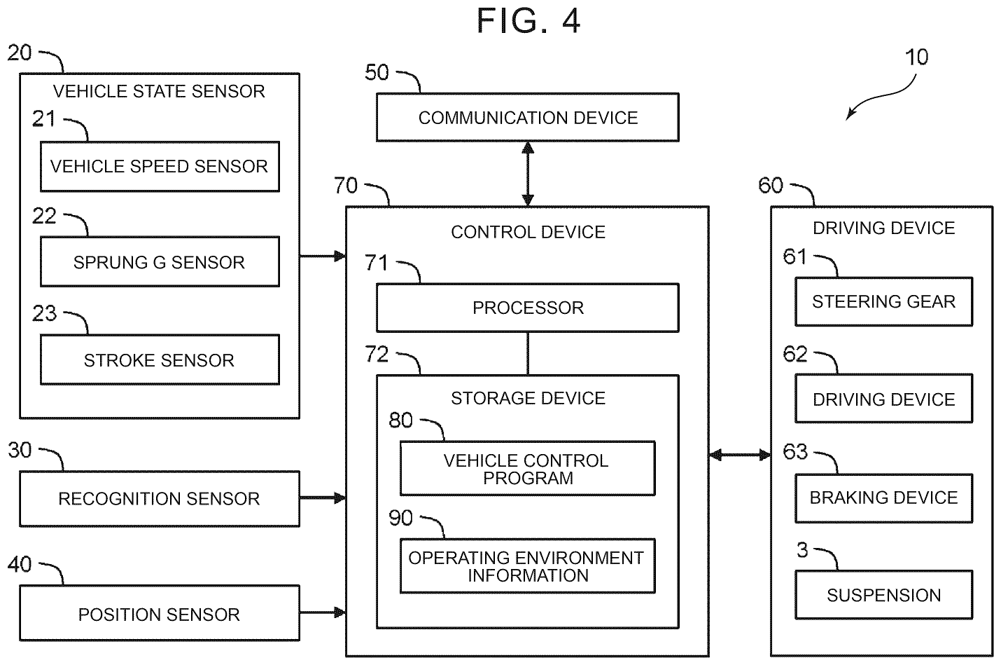

FIG. 4 is a block diagram illustrating a configuration example of the vehicle control system 10 according to the present embodiment. The vehicle control system 10 is applied to the vehicle 1 and controls the vehicle 1. For example, the vehicle control system 10 is mounted on the vehicle 1. As another example, the vehicle control system 10 may be distributed between the vehicle 1 and a remote device. The vehicle control system 10 includes a vehicle state sensor 20, a recognition sensor 30, a position sensor 40, a communication device 50, a traveling device 60, and a control device 70.

The vehicle state sensor 20 is mounted on the vehicle 1 and detects a state of the vehicle 1. The vehicle state sensor 20 includes a vehicle speed sensor (wheel speed sensor) 21 for detecting the vehicle speed V of the vehicle 1, a sprung acceleration sensor 22 for detecting the sprung acceleration Zs″, and the like. The vehicle-state sensor 20 may include a stroke sensor 23 that detects a stroke ST. The vehicle state sensor 20 may include an unsprung acceleration sensor. In addition, the vehicle state sensor 20 includes a lateral acceleration sensor, a yaw rate sensor, a steering angle sensor, and the like.

The recognition sensor 30 is mounted on the vehicle 1 and recognizes (detects) a situation around the vehicle 1. Examples of recognition sensors include cameras, LIDAR (Laser Imaging Detection and Ranging), radars, and the like.

The position sensor 40 is mounted on the vehicle 1 and includes a positioning device that detects the position and the azimuth of the vehicle 1. For example, the position sensor 40 includes a GNSS (Global Navigation Satellite System). For example, the position sensor 40 includes an RTK-GNSS.

The communication device 50 communicates with the outside of the vehicle 1.

The traveling device 60 includes a steering device 61, a driving device 62, a braking device 63, and a suspension 3 (see FIG. 2) mounted on the vehicle 1. The steering device 61 steers the wheels 2. For example, the steering device 61 may include a power steering (EPS: Electric Power Steering) Includes devices. The driving device 62 is a power source that generates driving force. Examples of the driving device 62 include an engine, an electric motor, and an in-wheel motor. The braking device 63 generates a braking force.

The control device 70 is a computer that controls the vehicle 1. The control device 70 may be mounted on the vehicle 1 or may be partially included in the remote device. The control device 70 includes one or multiple processors 71 (hereinafter simply referred to as processors 71) and one or multiple storage devices 72 (hereinafter simply referred to as storage devices 72). The processor 71 executes various processes. For example, the processor 71 includes a CPU (Central Processing Unit). The processor 71 may also be referred to as processing circuit (processing circuitry). The storage device 72 stores various kinds of information necessary for processing by the processor 71. Examples of the storage device 72 include volatile memory, non-volatile memory, HDD (Hard Disk Drive), SSD (Solid State Drive), and the like. The control device 70 may include one or multiple ECU (Electronic Control Unit).

The vehicle control program 80 is a computer program for controlling the vehicle 1, and is executed by the processor 71. The vehicle control program 80 is stored in the storage device 72. Alternatively, the vehicle control program 80 may be recorded in a computer-readable recording medium. When the processor 71 executes the vehicle control program 80, the function of the control device 70 is realized.

### 2-2. Operating Environment Information

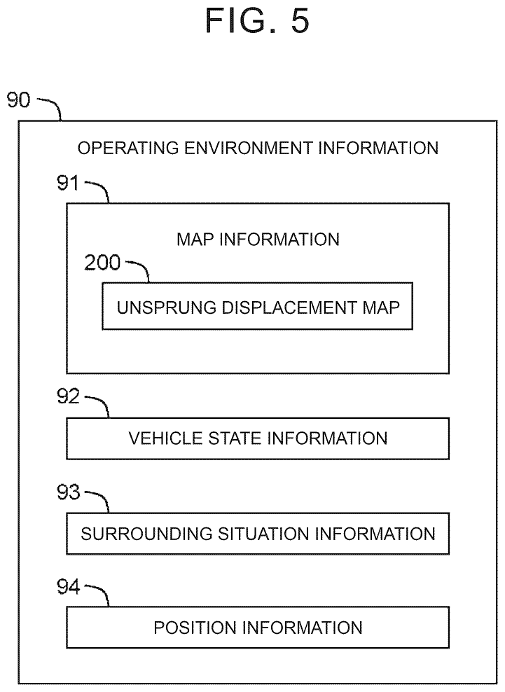

FIG. 5 is a block diagram illustrating an example of driving environment information 90 indicating a driving environment of the vehicle 1. The driving environment information 90 is stored in the storage device 72. The driving environment information 90 includes map information 91, vehicle state information 92, surrounding situation information 93, and position information 94.

The map information 91 includes a general navigation map. The map information 91 may indicate a lane arrangement, a road shape, and the like. The map information 91 may include positional information such as a white line, a traffic light, a sign, and a landmark. The map information 91 is obtained from a map database. The map database may be mounted on the vehicle 1 or may be stored in an external management server. In the latter case, the control device 70 communicates with the management server and acquires necessary map information 91.

The map information 91 further includes an “unsprung displacement map 200”. Details of the unsprung displacement map 200 will be described later.

The vehicle state information 92 is information indicating the state of the vehicle 1. The control device 70 acquires the vehicle state information 92 from the vehicle state sensor 20. For example, the vehicle state information 92 includes a vehicle speed V, a sprung acceleration Zs″, a stroke ST, a lateral acceleration, a yaw rate, a steering angle, and the like. The vehicle speed V may be calculated from the vehicle position detected by the position sensor 40. The control device 70 may calculate the unsprung displacement Zu by the method illustrated in FIG. 3. The vehicle-state-information 92 then also includes the unsprung displacement Zu calculated by the control device 70.

The surrounding situation information 93 is information indicating a situation around the vehicle 1. The control device 70 recognizes a situation around the vehicle 1 using the recognition sensor 30, and acquires the surrounding situation information 93. For example, the surrounding situation information 93 includes image information captured by the camera. Alternatively, the neighborhood situation information 93 includes point cloud information obtained by LIDAR.

The surrounding situation information 93 further includes “object information” regarding an object around the vehicle 1. Examples of the object include a pedestrian, a bicycle, another vehicle (a preceding vehicle, a parked vehicle, and the like), a road configuration (a white line, a curb, a guardrail, a wall, a central separation band, a roadside structure, and the like), a sign, a pole, an obstacle, and the like. The object information indicates a relative position and a relative speed of the object with respect to the vehicle 1. For example, by analyzing image information obtained by a camera, an object can be identified and a relative position of the object can be calculated. It is also possible to identify an object based on the point cloud data obtained by LIDAR, and to acquire the relative position and the relative velocity of the object.

The position information 94 is information indicating the position and the azimuth of the vehicle 1. The position includes a horizontal position and a vertical position. For example, the horizontal position is defined by latitude and longitude. The vertical position is defined by height (altitude). Examples of the altitude include sea level, geoid height, ellipsoidal height, and the like. The control device 70 acquires the position information 94 based on the measurement by the position sensor 40 such as a GNSS. As another example, the control device 70 may acquire the position information 94 by dead reckoning. As yet another example, the control device 70 may acquire the highly accurate position information 94 by a well-known (Localization) using the object information and the map information 91.

### 2-3. Vehicle Control

The control device 70 executes vehicle travel control for controlling travel of the vehicle 1. The vehicle travel control includes steering control, drive control, and braking control. The control device 70 executes vehicle travel control by controlling the traveling device 60 (the steering device 61, the driving device 62, and the braking device 63). The control device 70 may perform driving support control for supporting driving of the vehicle 1 based on the driving environment information 90. Examples of the driving assistance control include lane keeping control, collision avoidance control, and automatic driving control.

Furthermore, the control device 70 controls the suspension 3. Typically, the control device 70 controls the suspension 3 to perform damping control for suppressing vibration of the sprung structure 5 of the vehicle 1 (object vehicle). For example, the control device 70 controls the actuator 3A to generate an up-down direction control force Fc between the unsprung structure 4 and the sprung structure 5 (see FIG. 2), thereby suppressing vibrations of the sprung structure 5. Alternatively, the control device 70 may variably control the damping force of the damper 3D. The damping control includes “preview control” described later.

### 3. Map Management System

### 3-1. Configuration Example

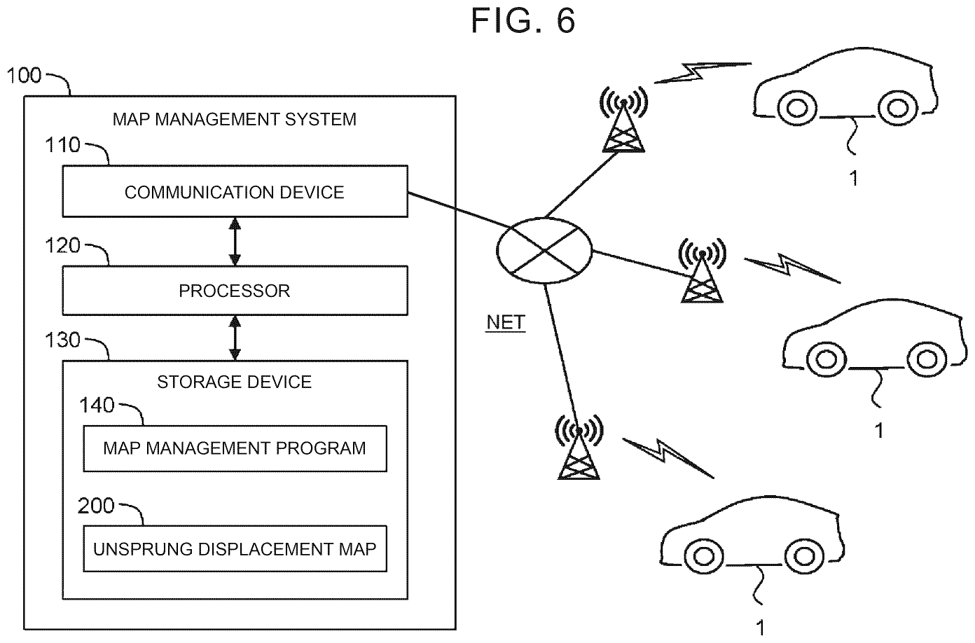

FIG. 6 is a block diagram illustrating a configuration example of the map management system 100 according to the present embodiment. The map management system 100 is a computer that manages various types of map information. The management of the map information includes generation, update, provision, distribution, and the like of the map information. Typically, the map management system 100 is a management server on the cloud. The map management system 100 may be a distributed system in which a plurality of servers perform distributed processing.

The map management system 100 includes a communication device 110. The communication device 110 is connected to a communication networking NET. For example, the communication device 110 communicates with a large number of vehicles 1 via a communication networking NET.

The map management system 100 further includes one or multiple processors 120 (hereinafter simply referred to as processors 120) and one or multiple storage devices 130 (hereinafter simply referred to as storage devices 130). The processor 120 executes various types of information processing. For example, the processor 120 includes a CPU. The processor 120 may also be referred to as processing circuitry. The storage device 130 stores various types of map information. The storage device 130 stores various kinds of information necessary for processing by the processor 120. Examples of the storage device 130 include a volatile memory, a nonvolatile memory, and an HDD, SSD.

The map management program 140 is a computer program for map management, and is executed by the processor 120. The map management program 140 is stored in the storage device 130. Alternatively, the map management program 140 may be recorded in a computer-readable recording medium. When the processor 120 executes the map management program 140, the functions of the map management system 100 are realized.

The processor 120 communicates with the vehicle control system 10 of the vehicle 1 via the communication device 110. The processor 120 collects various types of information from the vehicle control system 10, and generates and updates map information based on the collected information. Further, the processor 120 distributes the map information to the vehicle control system 10. The processor 120 also provides map information in response to a request from the vehicle control system 10.

### 3-2. Unsprung Displacement Map

One of the map information managed by the map management system 100 is “unsprung displacement map (up-down motion parameter map) 200”. The unsprung displacement map 200 is a map relating to the unsprung displacement Zu (up-down motion parameter), and indicates a correspondence between the unsprung displacement Zu (up-down motion parameter) and the position. The unsprung displacement map 200 is stored in the storage device 130.

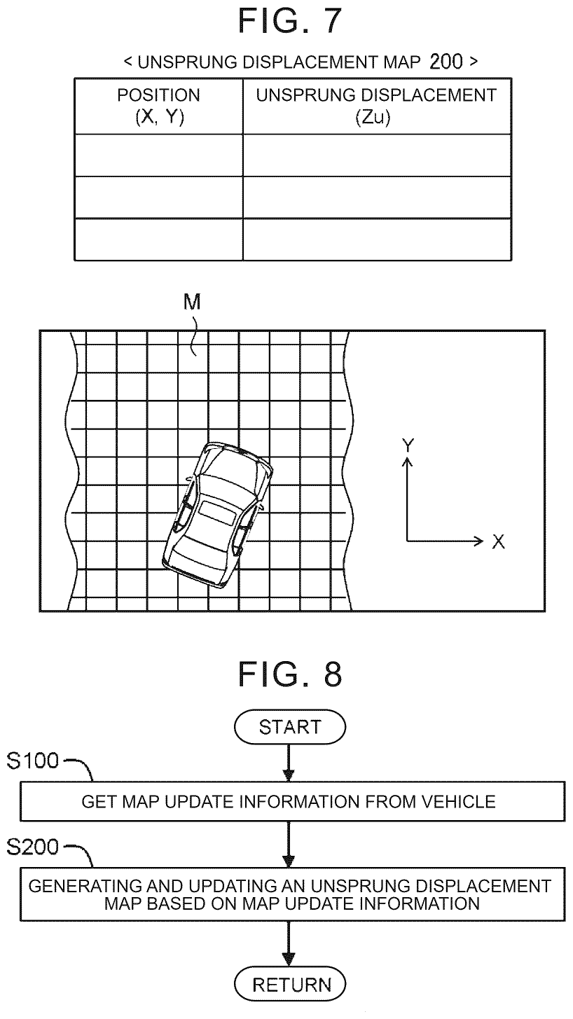

FIG. 7 is a conceptual diagram for explaining the unsprung displacement map 200. XY plane represents a horizontal plane. For example, an absolute coordinate system in a horizontal plane is defined by a latitude direction and a longitude direction, and a horizontal position is defined by a latitude and a longitude. The unsprung displacement map 200 represents a correspondence between at least horizontal position X, Y and the unsprung displacement Zu. In other words, the unsprung displacement map 200 represents the unsprung displacement Zu as a function of at least horizontal position X, Y.

The road area may be partitioned into meshes on a horizontal plane. That is, the road area may be divided into a plurality of unit areas M on the horizontal plane. The unit area M is, for example, a square. The length of one side of the square is, for example, 10 cm. The unsprung displacement map 200 represents a correspondence between the position of the unit area M and the unsprung displacement Zu. The position of the unit area M may be defined by a representative position (e.g., center position) of the unit area M, or may be defined by a range (latitude range, longitude range) of the unit area M. The unsprung displacement Zu of the unit area M is, for example, the mean of the unsprung displacement Zu acquired in the unit area M. As the unit area M decreases, the resolution of the unsprung displacement map 200 increases.

### 3-3. Map Generation and Update Processing

The processor 120 collects information from a large number of vehicles 1 via the communication device 110. Then, the processor 120 generates and updates the unsprung displacement map 200 based on the information collected from the plurality of vehicles 1. Hereinafter, examples of the map generation and update processing will be described in more detail.

The position in the unsprung displacement map 200 is a position where the wheel 2 has passed. The position of each wheel 2 is calculated based on the position information 94. Specifically, the relative positional relationship between the reference point of the vehicle position in the vehicle 1 and each wheel 2 is known information. The position of each wheel 2 can be calculated based on the relative positional relationship and the vehicle position indicated by the positional information 94.

The unsprung displacement Zu is calculated by the method shown in FIG. 3. That is, by using the vehicle state sensor 20 mounted on the vehicle 1, the sprung displacement Zs and the stroke ST can be obtained. These sprung displacement Zs and stroke ST are referred to as “sensor-based information” for convenience. The unsprung displacement Zu is calculated based on the sensor-based information.

For example, during traveling of the vehicle 1, the control device 70 of the vehicle control system 10 calculates the unsprung displacement Zu in real time based on the sensor-based information. The control device 70 also associates the same-timed wheel position with the unsprung displacement Zu. Then, the control device 70 transmits a set of time-series data of the wheel position and time-series data of the unsprung displacement Zu to the map management system 100. The processor 120 of the map management system 100 generates and updates the unsprung displacement map 200 based on the time series data of the wheel position and the time series data of the unsprung displacement Zu.

As another example, the control device 70 of the vehicle control system 10 associates wheel positions of the same timing with sensor-based information. Then, the control device 70 transmits a set of time-series data of the wheel position and time-series data of the sensor base information to the map management system 100. The processor 120 of the map management system 100 calculates the unsprung displacement Zu based on the received sensor-based data. Further, the processor 120 generates and updates the unsprung displacement map 200 based on the time series data of the wheel position and the time series data of the unsprung displacement Zu.

Note that when the unsprung displacement Zu is calculated in the map management system 100, since there is no restriction on the processing duration, the filtering processing can be performed using the zero-phase filter. By using a zero phase filter, “phase shift” can be suppressed.

FIG. 8 is a flowchart summarizing the map generation and update processing according to the present embodiment.

In S100, the processor 120 of the map management system 100 acquires “map updating information” from the vehicle 1 (the vehicle control system 10) via the communication device 110. The map update information includes time-series data of the position (wheel position) of the vehicle 1. The map updating information includes time-series data of sensor-based information (e.g., sprung displacement Zs, stroke ST) required for calculating the unsprung displacement Zu. Alternatively, the information for updating the map may include time-series data of the unsprung displacement Zu calculated by the control device 70 of the vehicle control system 10.

In S200, the processor 120 of the map management system 100 generates and updates the unsprung displacement map 200 based on the map updating data.

### 3-4. Modification

Vehicle control system 10 of vehicle 1 may hold a database of unsprung displacement maps 200 and generate and update its unsprung displacement maps 200. That is, the map management system 100 may be included in the vehicle control system 10.

### 4. Preview Control Using Unsprung Displacement Map

The control device 70 of the vehicle control system 10 communicates with the map management system 100 via the communication device 50. The control device 70 acquires the unsprung displacement map 200 of the area including the current position of the vehicle 1 from the map management system 100. The unsprung displacement map 200 is stored in the storage device 72. Then, the control device 70 executes “preview control”, which is a kind of damping control, based on the unsprung displacement map 200.

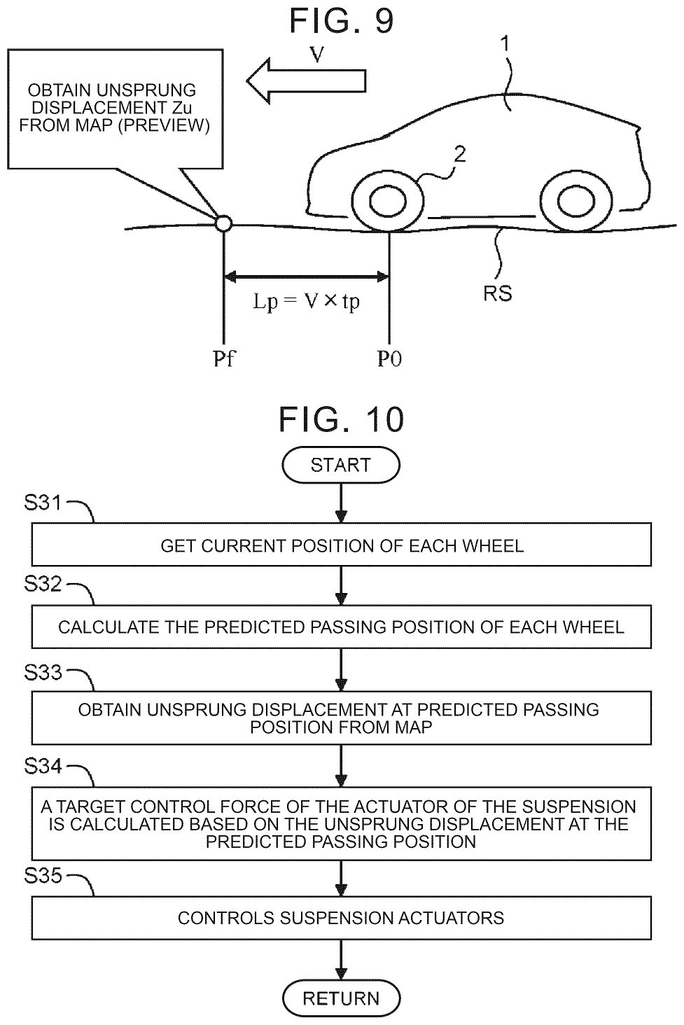

FIG. 9 is a conceptual diagram for explaining preview control. FIG. 10 is a flowchart illustrating preview control. The preview control will be described with reference to FIGS. 9 and 10.

In S31, the control device 70 acquires the present position P0 of the respective wheels 2. The relative positional relationship between the reference point of the vehicle position in the vehicle 1 and each wheel 2 is known information. The position of each wheel 2 can be calculated based on the relative positional relationship and the vehicle position indicated by the positional information 94.

In S32, the control device 70 calculates the predicted passing position Pf of the wheel 2 after the preview-time tp. The preview time tp is set to be equal to or longer than a time required for a computation process or a communication process required for operating the actuator 3A of the suspension 3, for example. The preview-time tp may be fixed or may be variable depending on the circumstances. The preview distance Lp is given by the product of the preview time tp and the vehicle speed V. The predicted passing position Pf is a position forward by the preview-distance Lp from the present position P0. As a modification, the control device 70 may calculate the predicted traveling route based on the vehicle speed V and the steering angle of the wheel 2, and may calculate the predicted passing position Pf based on the predicted traveling route.

In S33, the control device 70 reads out the unsprung displacement Zu in the predicted passing position Pf from the unsprung displacement map 200.

In S34, the control device 70 calculates the target control force Fc_t of the actuator 3A of the suspension 3 based on the unsprung displacement Zu in the predicted passing position Pf. The target control force Fc_t is calculated as follows, for example.

The equation of motion for the sprung structure 5 (see FIG. 2) is represented by the following expression (1):

$$( Mathematical expression 1 )$$

$$m \cdot {Zs}^{′′} = C ( {Zu}^{′} - {Zs}^{′} ) + K ( Zu - Zs ) - Fc \qquad ( 1 )$$

In Expression (1), m is the mass of the sprung structure 5, C is the damping factor of the damper 3D, K is the spring constant of the spring 3S, and Fc is the up-down direction control force Fc generated by the actuator 3A. If the control force Fc completely cancels the vibration of the sprung structure 5 (Zs″=0, Zs′=0, Zs=0), the control force Fc is expressed by the following expression (2).

$$( Mathematical expression 2 )$$

$$Fc = C \cdot {Zu}^{′} + K \cdot Zu \qquad ( 2 )$$

The control force Fc providing at least the damping effect is expressed by the following expression (3).

$$( Mathematical expression 3 )$$

$$Fc = α \cdot C \cdot {Zu}^{′} + β \cdot K \cdot Zu \qquad ( 3 )$$

In Expression (3), the gain a is greater than α and less than or equal to 1, and the gain β is also greater than 0 and less than or equal to 1. When the differential term in expression (3) is omitted, the control force Fc that provides at least the damping effect is expressed by the following expression (4).

$$( Mathematical expression 4 )$$

$$Fc = β \cdot K \cdot Zu \qquad ( 4 )$$

The control device 70 calculates the target control force Fc_t according to expression (3) or expression (4). That is, the control device 70 calculates the target control force Fc_t by substituting the unsprung displacement Zu in the predicted passing position Pf into the expression (3) or the expression (4).

In S35, the control device 70 controls the actuator 3A so as to generate the target control force Fc_t at a timing at which the wheel 2 passes through the predicted passing position Pf. The timings at which the wheels 2 pass through the predicted passing position Pf are known from the preview-time tp.

By the preview control using the unsprung displacement map 200 described above, the vibration of the vehicle 1 (the sprung structure 5) can be effectively suppressed.

### 5. Reliability of Preview Control

As described above, in the preview control, the unsprung displacement Zu obtained from the unsprung displacement map 200 is used. For convenience, the unsprung displacement Zu obtained from the unsprung displacement map 200 is referred to as “unsprung displacement Zu_map”. If the accuracy of the unsprung displacement Zu_map obtained from the unsprung displacement map 200 is low, the accuracy of the preview control using the unsprung displacement Zu_map may also decrease. Therefore, it is preferable to know how reliable the unsprung displacement Zu_map, that is, the preview control is. The reliability of the preview control is hereinafter referred to as “preview reliability R”. Hereinafter, a calculation example of the preview reliability R will be described.

5-1. Situations with Reduced Map Reliability

Road surfaces (road surface state, road surface irregularities) may change due to factors such as road construction, earthquakes, etc. If the road surface change is not reflected in the unsprung displacement map 200, the unsprung displacement Zu_map obtained from the unsprung displacement map 200 is not necessarily accurate. Therefore, it can be said that the preview reliability R is low in such a situation.

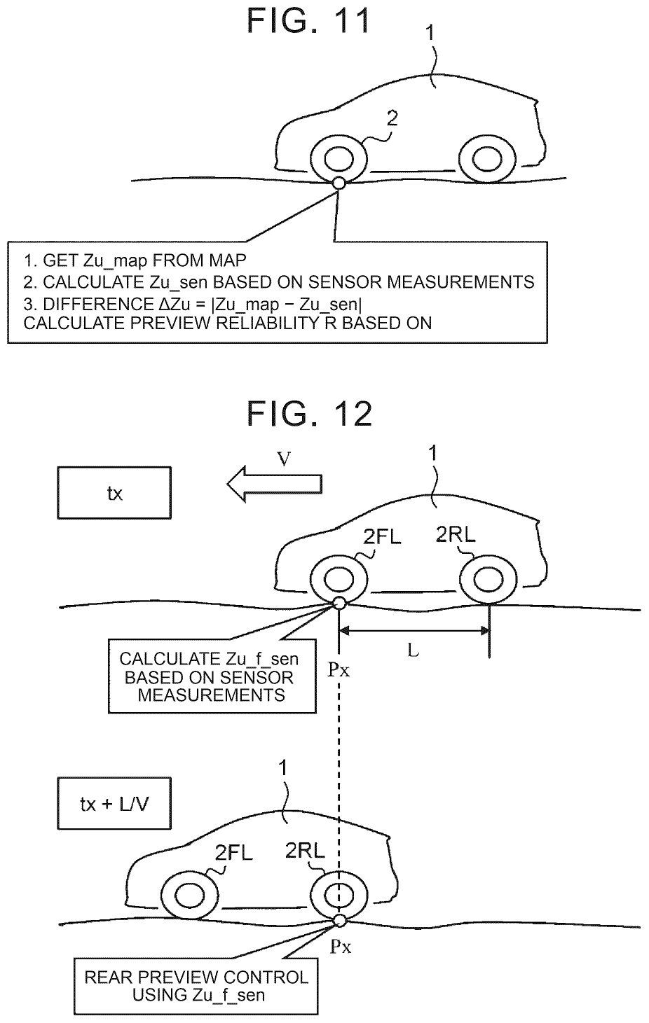

FIG. 11 is a conceptual diagram for explaining an example of a method of calculating the preview reliability R. First, the vehicle control system 10 or the map management system 100 acquires the unsprung displacement Zu_map at a certain wheel position from the unsprung displacement map 200. Further, the vehicle control system 10 or the map management system 100 calculates the unsprung displacement Zu_sen at the same wheel position according to the method illustrated in FIG. 3 (calculates Zu_sen based on the sensor measurement value). The unsprung displacement Zu_sen is calculated based on the measurement result by the in-vehicle sensor, and does not depend on the unsprung displacement map 200. Subsequently, the vehicle control system 10 or the map management system 100 calculates a difference AZu (AZu=|Zu_map-Zu_sen|) between the unsprung displacement Zu_map and the unsprung displacement Zu_sen at the same wheel position. Then, the vehicle control system 10 or the map management system 100 calculates the preview reliability R at the wheel position based on the difference AZu. Specifically, the smaller the difference AZu is, the higher the preview reliability R becomes. Conversely, the larger the difference AZu, the lower the preview reliability R.

The calculation cycle of the preview reliability R may be longer than the control cycle of the preview control. For example, a section in which a road surface has changed due to road construction, an earthquake, or the like has a certain distance. When the vehicle 1 enters the interval, the preview reliability R decreases, and thereafter, a state in which the preview reliability R is low continues to some extent. Since the interval in which the preview reliability R is low continues to some extent, the calculation cycle of the preview reliability R may be longer than the control cycle of the preview control.

In order to suppress the “phase shift” between the unsprung displacement Zu_map and the unsprung displacement Zu_sen, the unsprung displacement Zu_map and the unsprung displacement Zu_sen may be calculated through the same filtering process. For example, both the unsprung displacement Zu_map and the unsprung displacement Zu_sen may be calculated by a zero phase filter in the map management system 100.

5-2. Situations with Reduced Reliability of Position Information

In the preview control, the position information 94 is used to acquire the position of the wheel 2. When the accuracy of the position information 94 is low, the accuracy of the position of the wheel 2 is low. If the accuracy of the position of the wheel 2 is low, the unsprung displacement Zu_map read out from the unsprung displacement map 200 may deviate from the unsprung displacement Zu in the actual position of the wheel 2. Therefore, it can be said that the preview reliability R is low even in such a situation. Hereinafter, an example of a method of calculating the reliability of the position information 94, that is, the preview reliability R will be described.

The position information 94 is obtained based on a measurement result by the position sensor 40 mounted on the vehicle 1. The position information 94 includes the horizontal position and the vertical position of the vehicle reference point of the vehicle 1. The horizontal position is defined by latitude and longitude. The vertical position is defined by height (altitude). Examples of the altitude include sea level, geoid height, ellipsoidal height, and the like. The vehicle reference point is optional. For example, the vehicle reference point may be a vehicle center point or a mounting position of the position sensor 40. The design value (default value) of the relative height of the vehicle reference point from the road surface is given as known information. Furthermore, the relative height of the vehicle reference point from the road surface may be corrected by considering the stroke ST of the suspension 3, the inclination of the vehicle body (roll angle, pitch angle), the tire deflection, and the like. In either case, the relative height of the vehicle reference point from the road surface is obtained. The vehicle control system 10 or the map management system 100 calculates the altitude of the road surface at the horizontal position of the vehicle 1 based on the vertical position of the vehicle 1 included in the position information 94. The road surface altitude obtained on the basis of the position information 94 is hereinafter referred to as “sensor-based altitude Hsen”.

On the other hand, an “altitude map” indicating a correspondence relation between latitude, longitude, and altitude of a road surface (ground surface) is prepared in advance. For example, map data issued by the Geographical Survey Institute may be used as an altitude map. The vehicle control system 10 or the map management system 100 reads the altitude of the road surface at the horizontal position of the vehicle 1 from the altitude map. The road surface altitude obtained from the altitude map in this way is hereinafter referred to as “map-based altitude Hmap”.

The vehicle control system 10 or the map management system 100 calculates an altitude deviation ΔH(=|Hsen−Hmap|) between the sensor-based altitude Hsen and the map-based altitude Hmap. Then, the vehicle control system 10 or the map management system 100 calculates the preview reliability R based on the altitude deviation ΔH. Specifically, the smaller the height deviation ΔH is, the higher the preview reliability R is. Conversely, the higher the height deviation ΔH, the lower the preview reliability R.

### 5-3. Vehicle Speed

The error of the position information 94 acquired by using the position sensor 40 such as a GNSS receiver tends to be large when the vehicle speed V is low. This is because, when the vehicle speed V is low, it becomes difficult to specify the traveling direction of the vehicle 1. Therefore, the lower the vehicle speed V, the lower the preview reliability R may be set.

### 6. Combination of Preview Control and Non-Map-Dependent Control

### 6-1. Overview

In the following explanation, an object to be controlled by the vehicle control system 10 (the control device 70) is referred to as “object vehicle 1T” for convenience. The object vehicle 1T includes an actuator 3A that applies a up-down direction control force Fc to the suspensions 3 of the target wheels (see FIG. 2). The control device 70 executes “damping control” for controlling the actuator 3A to suppress the vibration of the sprung structure 5 on the object wheel.

An example of damping control is preview control utilizing the unsprung displacement Zu_map obtained from the unsprung displacement map 200. Although the control performance of the preview control is high, there may also be situations in which the preview reliability R of the preview control is degraded, as described in section 5 above. Therefore, according to the present embodiment, in order to compensate for the preview control, another damping control that does not use the unsprung displacement map 200 is performed together with the preview control. Other damping controls that do not utilize the unsprung displacement map 200 are hereinafter referred to as “non-map-dependent controls.” That is, the damping control according to the present embodiment is a combination of preview control and non-map-dependent control.

An example of non-map-dependent control is general feedback control. For example, unsprung feedback control that suppresses vibration based on unsprung displacement Zu_sen is applied. The unsprung displacement Zu_sen is calculated in real time according to the method shown in FIG. 3 based on the measurement result by the sensor mounted on the object vehicle 1T. The unsprung feedback control utilizes the unsprung displacement Zu_sen calculated in real time, rather than the unsprung displacement Zu_map obtained from the unsprung displacement map 200. When the damping control is a combination of the preview control and the feedback control, the control force Fc is expressed by, for example, the following expression (5).

$$( Mathematical expression 5 )$$

$$Fc = Gpre \cdot Zu\_map + Gfb \cdot Zu\_sen \qquad ( 5 )$$

The first term on the right side of Expression (5) represents a control force by preview control. The preview gain Gpre is the gain of the preview control, and corresponds to “β·K” in the above expression (4). β takes a value from 0 to 1. K is the up-down spring constant of the spring 3S of the suspension of the target wheel of the object vehicle 1T. The second term on the right side of expression (5) represents the control force by feedback control. The feedback gain Gfb is a gain of the feedback control.

Due to the effects of the integration error and the filtering process, the control performance of the feedback control is not as high as the preview control. However, since the unsprung displacement Zu_sen calculated in real time is used instead of the unsprung displacement Zu_map obtained from the unsprung displacement map 200, it can be said that the reliability (certainty) of the feedback control is always high. Therefore, even in a situation in which the preview reliability R of the preview control is low, the damping effect can be obtained to some extent by the feedback control.

Another example of non-map-dependent control is “rear preview control”. The rear preview control will be described with reference to FIG. 12. Here, the combination of the left front wheel 2FL and the left rear wheel 2RL will be described, but the same applies to the combination of the right front wheel 2FR and the right rear wheel 2RR. In the rear preview control, it is assumed that the left front wheel 2FL and the left rear wheel 2RL of the object vehicle 1T pass through the same position. First, in the timing tx where the left front wheel 2FL passes through a certain position Px, the unsprung displacement Zu_sen is calculated in real time by the method shown in FIG. 3. This unsprung displacement Zu_sen is referred to as a front wheel unsprung displacement Zu_f_sen for convenience. After a period of L/V has elapsed from the timing tx, the left rear wheel 2RL passes through the same position Px. Here, L is a wheelbase between the left front wheel 2FL and the left rear wheel 2RL, and V is a vehicle speed of the object vehicle 1T. In the timing tx+L/V, instead of the unsprung displacement Zu_map, the preview control for the left rear wheel 2RL is performed using the unsprung displacement Zu_f_sen calculated above.

The rear preview control does not use the unsprung displacement map 200, and therefore is not affected by the preview reliability R. When the damping control is a combination of the preview control and the rear preview control, the control force Fc is expressed by, for example, the following Expression (6).

$$( Mathematical expression 6 )$$

$$Fc = Gpre \cdot Zu\_r \_map + Grp \cdot Zu\_f \_sen \cdot {e}^{- τ s} \qquad ( 6 )$$

Similar to expression (5), the first term on the right side of expression (6) represents the control force by preview control. Zu_r_map is the unsprung displacement Zu_map read out from the unsprung displacement map 200 for preview control on the left rear wheel 2RL. The second term on the right side of expression (6) represents the control force by the rear preview control. The rear preview gain Grp is a gain of the rear preview control. e^{-ts} represents a time delay calculated from the wheelbase L and the vehicle speed V.

When Expression (5) and Expression (6) are generalized, the control force Fc when the damping control is a combination of the preview control and the non-map-dependent control is expressed by Expression (7) below.

$$( Mathematical expression 7 )$$

$$Fc = G 1 \cdot Zu\_map + G 2 \cdot Zu\_sen \qquad ( 7 )$$

The first term on the right side of expression (7) represents the control force by preview control. The first gain G1 is the preview gain Gpre. It can be said that the first gain G1 represents the contribution of the preview control to the entire damping control. The unsprung displacement Zu_map is obtained from the unsprung displacement map 200. The second term on the right side of expression (7) represents the control force by feedback control. The second gain G2 is the feedback gain Gfb in expression (5) or the rear preview gain Grp in expression (6). It can be said that the second gain G2 represents the contribution of the non-map-dependent control to the entire damping control. The unsprung displacement Zu_sen is calculated in real time according to the method shown in FIG. 3 based on the measurement result by the sensor mounted on the object vehicle 1T.

The control device 70 controls the actuator 3A in accordance with the control force Fc obtained by expression (7), and executes damping control that is a combination of preview control and non-map-dependent control. Therefore, even in a situation in which the preview reliability R of the preview control is low, the damping effect can be obtained by the non-map-dependent control.

### 6-2. Total Gain Setting

The total gain Gt is the sum of the first gain G1 for the preview control and the second gain G2 for the non-map-dependent control (Gt=G1+G2). If the total gain Gt becomes excessively large, the vibration may be increased rather than suppressed. In order to suppress such “excitation”, the total gain Gt needs to be appropriately set.

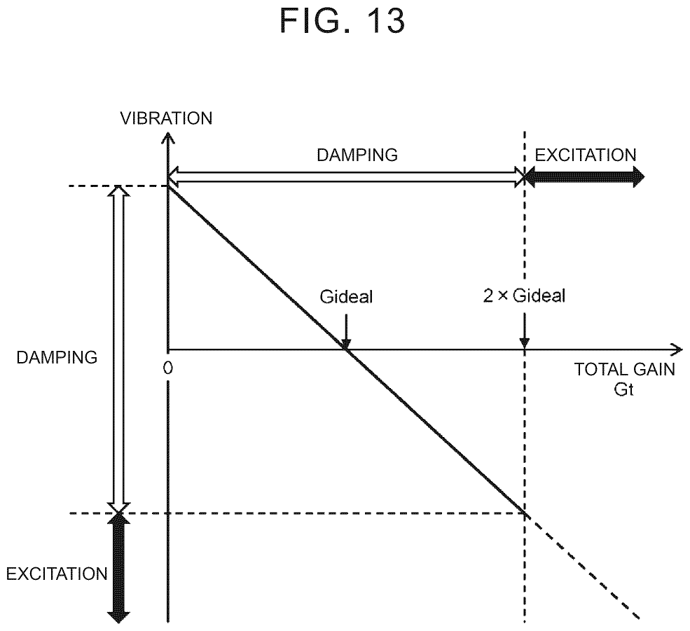

FIG. 13 is a conceptual diagram for explaining the setting of the total gain Gt of the damping control according to the present embodiment. The horizontal axis represents the total gain Gt, and the vertical axis represents the magnitude of vibration of the sprung structure 5. The idealized gain Gideal is a total gain Gt that minimizes the vibration of the sprung structure 5, and is determined in advance. As can be seen from the above expression (4), the idealized gain Gideal is, for example, K (Gideal=K). K is the up-down spring constant of the spring 3S of the suspension of the target wheel of the object vehicle 1T. The ideal gain data indicating the ideal gain Gideal is stored in advance in the storage device of the storage device 72 of the control device 70.

In FIG. 13, a Gt of 0 corresponds to a situation where the damping control is not performed. As the total gain Gt increases from 0, the vibration is suppressed and decreases. When the total gain Gt is in the idealized gain Gideal, the vibration is minimized. When the total gain Gt is larger than the ideal gain Gideal, the vibration is generated in the opposite direction to the case where the damping control is not performed. However, if the total gain Gt does not exceed twice the idealized gain Gideal, the magnitude of the vibration is smaller than that of Gt=0 even if the reverse-direction vibration occurs. In other words, if the total gain Gt does not exceed twice the idealized gain Gideal, no excitation occurs and at least the damping effect is obtained. When the total gain Gt is more than twice the idealized gain Gideal, excitation occurs.

As described above, according to the present embodiment, the total gain Gt is set to be greater than 0 and not more than twice the idealized gain Gideal. That is, the control device 70, so that the total gain Gt does not exceed twice larger and ideal gain Gideal than 0, sets the first gain G1 and second gain G2 (Gt=G1+G2<2. Gideal). Preferably, the control device 70 sets the first gain G1 and the second gain G2 so that the total gain Gt is in the vicinity of the ideal gain Gideal. Since the total gain Gt is set so as not to exceed twice the idealized gain Gideal, the damping effect can be reliably obtained without causing vibration.

### 6-3. Gain Setting Considering the Reliability of Preview Control

The control device 70 may flexibly adjust the respective contributions of the preview control and the non-map-dependent control in accordance with the preview reliability R of the preview control. That is, the control device 70 may flexibly adjust the proportion of the first gain G1 and the second gain G2 according to the preview reliability R of the preview control. Even if the proportion between the first gain G1 and the second gain G2 is changed, the total gain Gt is set as described in Section 6-2 above.

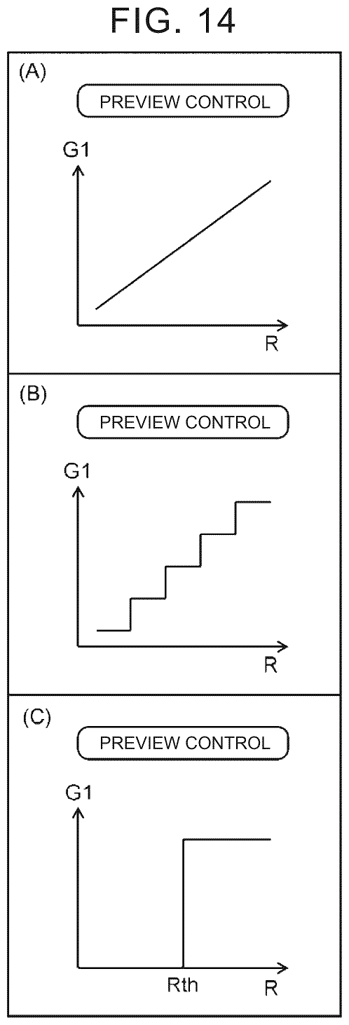

FIG. 14 is a conceptual diagram for describing various examples of gain settings in consideration of the preview reliability R. The horizontal axis represents the preview reliability R, and the vertical axis represents the first gain G1 of the preview control. In the example (A) in FIG. 14, the first gain G1 monotonically decreases as the preview reliability R decreases. In the embodiment (B) in FIG. 14, the first gain G1 gradually decreases as the preview reliability R decreases. In the example (C) in FIG. 14, the preview control is executed when the preview reliability R is equal to or greater than the threshold Rth, and the preview control is not executed when the preview reliability R is less than the threshold Rth (the first gain G1 is 0). Generalization is as follows: The preview reliability R1 in the first state is higher than the preview reliability R2 in the second state (R1>R2). The control device 70 makes the first gain G1 in the second state smaller than the first gain G1 in the first state. Accordingly, it is possible to suppress the preview control from being excessively performed when the preview reliability R is low. In addition, when the preview reliability R is high, preview control can be effectively performed.

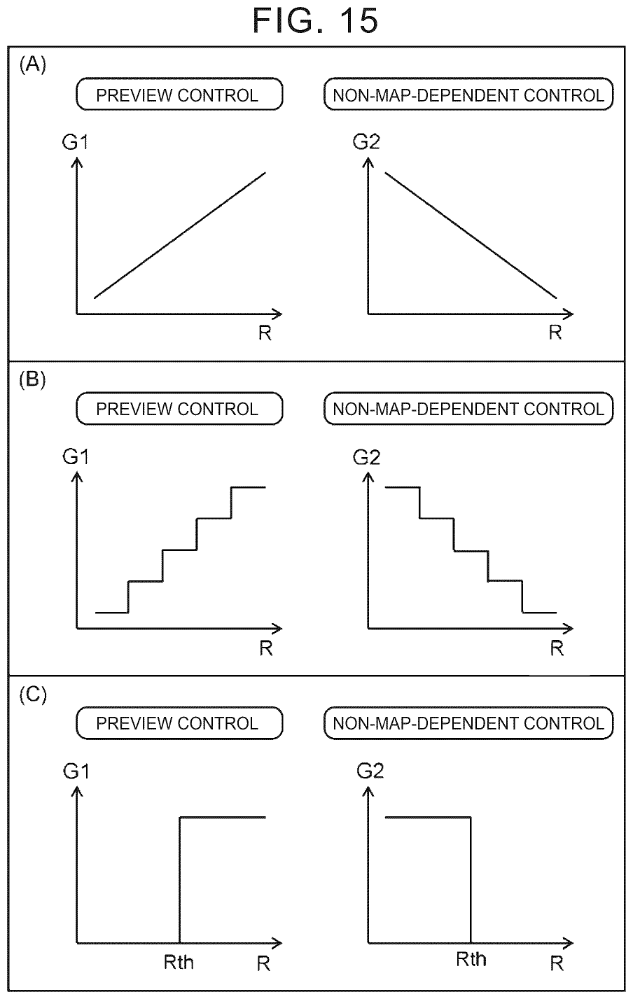

FIG. 15 is a conceptual diagram for explaining another example of gain setting in consideration of the preview reliability R. The horizontal axis represents the preview reliability R, and the vertical axis represents the first gain G1 of the preview control and the second gain G2 of the non-map-dependent control. In the example (A) in FIG. 15, as the preview reliability R decreases, the first gain G1 monotonically decreases, and instead, the second gain G2 monotonically increases. In the example (B) in FIG. 15, as the preview reliability R decreases, the first gain G1 decreases stepwise, and instead, the second gain G2 increases monotonically. In the example (C) in FIG. 15, the preview control is executed when the preview reliability R is equal to or greater than the threshold Rth, and the non-map-dependent control is executed instead of the preview control when the preview reliability R is less than the threshold Rth. Generalization is as follows: The preview reliability R1 in the first state is higher than the preview reliability R2 in the second state (R1>R2). The control device 70 makes the first gain G1 in the second state smaller than the first gain G1 in the first state. In addition, the control device 70 makes the second gain G2 in the second state larger than the second gain G2 in the first state. Accordingly, it is possible to suppress the preview control from being excessively performed when the preview reliability R is low, and to compensate for the effect of the damping control by the non-map-dependent control.

The example shown in FIGS. 14 and 15 is generalized as follows. The proportion G1/G2 is a ratio of the first gain G1 to the second gain G2. The preview reliability R1 in the first state is higher than the preview reliability R2 in the second state (R1>R2). The control device 70 sets the proportion G1/G2 in the second state to be lower than the proportion G1/G2 in the first state.

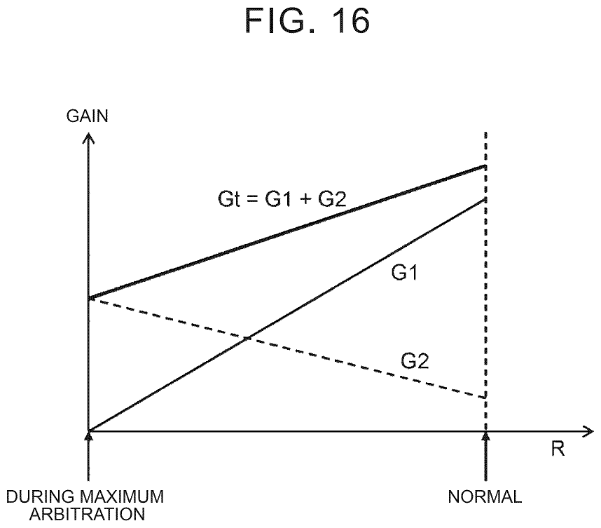

FIG. 16 is a conceptual diagram for explaining an example of gain setting in consideration of the preview reliability R. The horizontal axis represents the preview reliability R, and the vertical axis represents the first gain G1, the second gain G2, and the total gain Gt. In the embodiment shown in FIG. 16, the total gain Gt decreases as the preview reliability R decreases. For example, in a normal state in which the preview reliability R is sufficiently higher, the total gain Gt is set to the ideal gain Gideal. Then, as the preview reliability R decreases, the first gain G1 and the total gain Gt decrease. At maximal arbitration when the first gain G1 is 0, the total gain Gt is half of the idealized gain Gideal. Generalization is as follows: The preview reliability R1 in the first state is higher than the preview reliability R2 in the second state (R1>R2). The control device 70 makes the total gain Gt in the second state smaller than the total gain Gt in the first state. Thus, when the preview reliability R is low, the load and the power consumed by the actuator 3A can be reduced while a certain degree of damping is ensured.

What is claimed is:

1. A vehicle control system applied to an object vehicle that includes an actuator for applying control force in an up-down direction to a suspension of an object wheel, the vehicle control system comprising:
one or multiple processors that control the actuator to execute damping control for suppressing vibration in a sprung structure above the object wheel; and
one or multiple storage devices that store a map indicating a correspondence relation between an up-down motion parameter related to up-down motion of a wheel, and a position, wherein
the damping control includes
a preview control that uses the up-down motion parameter that is obtained from the map, and
a non-map-dependent control that uses the up-down motion parameter that is calculated based on a measurement result by a sensor that is installed in the object vehicle,
a total gain is a sum of a first gain for the preview control and a second gain for the non-map-dependent control,
an ideal gain is the total gain that minimizes the vibration of the sprung structure, and is set in advance, and
the one or multiple processors are configured to set the first gain and the second gain such that the total gain does not exceed twice the ideal gain.

2. The vehicle control system according to claim 1, wherein
reliability of the preview control in a first state is higher than reliability of the preview control in a second state,
a proportion is a ratio of the first gain to the second gain, and
the one or multiple processors are configured to make the proportion in the second state to be lower than the proportion in the first state.

3. The vehicle control system according to claim 2, wherein the one or multiple processors are configured to make the total gain in the second state to be smaller than the total gain in the first state.

4. The vehicle control system according to claim 1, wherein
the up-down motion parameter is unsprung displacement, and
the ideal gain is equal to an up-down spring constant of the suspension of the object wheel.

5. The vehicle control system according to claim 1, wherein the non-map-dependent control is feedback control or rear preview control.
